(19) United States
(12) Patent Application Publication
(10) Pub. No.: US 2025/0167849 A1
(43) Pub. Date: May 22, 2025

(54) TWO-STEP USER EQUIPMENT ASSISTED CODE BLOCK MAPPING ADAPTATION

(71) Applicant: QUALCOMM Incorporated, San Diego, CA (US)

(72) Inventors: Daniel PAZ, Atlit, Haifa District (IL); Michael LEVITSKY, Rehovot (IL)

(21) Appl. No.: 18/837,517

(22) PCT Filed: Mar. 20, 2023
(86) PCT No.: PCT/US2023/064688

§ 371 Date: Aug. 9, 2024

(30) Foreign Application Priority Data
Apr. 13, 2022 (IL) 292217

(51) Int. Cl. H04B 7/06; H04L 1/00; H04L 5/00

(52) U.S. Cl. CPC H04B 7/0626; H04L 1/0026; H04L 5/0057

(57) ABSTRACT

In a wireless communication system, dynamic changes of a code block (CB) to resource element (RE) mapping type may be based on a two-step procedure. A user equipment may provide an indication that a recommended CB mapping type is preferred over a current CB mapping type. The indication may be one or two bits in a periodic or per-allocation report. In response to the indication, a base station may trigger the UE to transmit an aperiodic CSI report. The aperiodic CSI report may include channel state feedback corresponding to one or more CB mapping types including the preferred CB mapping type. The base station may consider the UE recommended CB mapping type and channel state feedback when selecting a CB mapping type.

### CROSS REFERENCE TO RELATED APPLICATION(S)

This application claims the benefit of Israel Patent Application Serial No. 292217, entitled “TWO-STEP USER EQUIPMENT ASSISTED CODE BLOCK MAPPING ADAPTATION” and filed on Apr. 13, 2022, which is assigned to the assignee hereof, and incorporated herein by reference in its entirety.

### BACKGROUND

### Technical Field

The present disclosure relates generally to communication systems, and more particularly, to two-step user equipment (UE) assisted code block (CB) mapping adaptation.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a non-transitory computer-readable medium, and an apparatus for a user equipment (UE) are provided. The method includes transmitting an indicator that a recommended CB mapping type is preferred by the UE over a current CB mapping type. The method includes receiving a trigger of an aperiodic channel state information (CSI) report associated with CB mapping information. The method includes transmitting the aperiodic CSI report for one or more CB mapping types in response to the trigger.

The present disclosure also provides an apparatus (e.g., a UE) including a memory storing computer-executable instructions and at least one processor configured to execute the computer-executable instructions to perform the above method, an apparatus including means for performing the above method, and a non-transitory computer-readable medium storing computer-executable instructions for performing the above method.

In another aspect, the disclosure provides a method, a non-transitory computer-readable medium, and an apparatus for a base station. The method includes receiving an indicator that a recommended CB mapping type is preferred by a UE over a current CB mapping type for the UE. The method includes transmitting a trigger of an aperiodic CSI report associated with CB mapping information. The method includes receiving the aperiodic CSI report for one or more CB mapping types in response to the trigger.

The present disclosure also provides an apparatus (e.g., a base station) including a memory storing computer-executable instructions and at least one processor configured to execute the computer-executable instructions to perform the above method, an apparatus including means for performing the above method, and a non-transitory computer-readable medium storing computer-executable instructions for performing the above method.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system including an access network, in accordance with certain aspects of the present description.

FIG. 2A is a diagram illustrating an example of a first frame, in accordance with certain aspects of the present description.

FIG. 2B is a diagram illustrating an example of downlink (DL) channels within a subframe, in accordance with certain aspects of the present description.

FIG. 2C is a diagram illustrating an example of a second frame, in accordance with certain aspects of the present description.

FIG. 2D is a diagram illustrating an example of uplink (UL) channels within a subframe, in accordance with certain aspects of the present description.

FIG. 3 is a diagram illustrating an example of a base station and user equipment (UE) in an access network, in accordance with certain aspects of the present description.

FIG. 4 shows a diagram illustrating an example disaggregated base station architecture.

FIG. 5 is a diagram illustrating various code block (CB) to resource element (RE) mapping types.

FIG. 6 is a message diagram illustrating example messages for a two-step UE assisted dynamic CB mapping adaptation.

FIG. 7 is a diagram of example uplink control information (UCI) formats for the aperiodic CSI report.

FIG. 8 is a conceptual data flow diagram illustrating the data flow between different means/components in an example base station.

FIG. 9 is a conceptual data flow diagram illustrating the data flow between different means/components in an example UE.

FIG. 10 is a flowchart of an example method for a UE to perform a two-step recommendation for dynamic CB mapping.

FIG. 11 is a flowchart of an example method for a base station to perform a two-step UE assisted dynamic CB mapping adaptation.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Although the following description may be focused on 5G NR, the concepts described herein may be applicable to other similar areas, such as LTE, LTE-A, CDMA, GSM, and other wireless technologies.

Conventional 5G NR systems utilize a frequency first mapping of code blocks (CBs) to resource elements (REs). That is, bits of a CB may be sequentially allocated to REs in order of the RE index. Where a transmission includes multiple layers, the frequency first mapping allocates bits of the CB across the multiple layers at an RE index, then moves to the next RE index. Other mapping types for CB to RE mapping may perform better than a frequency first mapping in some scenarios. Other mapping types include a time first, frequency first per layer, and time first per layer, for example. For instance, a time first mapping may provide better performance than a frequency first mapping for high mobility scenarios (e.g., 120 kilometers per hour) with relatively high signal to noise ratio (SNR) (e.g., above 20 dB). As another example, frequency first per layer mapping may provide better performance than frequency first mapping in low mobility scenarios with high SNR. Dynamic selection of a mapping type may improve performance at a UE.

One issue with dynamic selection of mapping type is coordination between the base station and UE regarding the mapping type for a transmission. Conventionally, the base station makes decisions about UE scheduling and transmission properties based on channel state feedback (CSF) from the UE such as channel state information (CSI). For example, a UE may transmit a CSI report that includes a channel quality indicator (CQI) and rank indicator (RI) that are based on estimated decoding performance of the UE. The base station may then use the CQI and RI to schedule physical downlink shared channel (PDSCH) transmissions with a modulation and coding scheme (MCS) and rank that the UE is likely to be able to decode. The UE may determine CSI to report based on a current CB mapping type. Such a CSI report may not provide sufficient information for a base station to evaluate the effectiveness of different CB mapping types. A UE may have access to other information that is useful for identifying a CB mapping type, but there may be no reporting mechanism for providing the other information to the base station. Further, because a change in CB mapping type may occur relatively infrequently, it may be desirable to minimize overhead for feedback regarding CB mapping type.

In an aspect, the present disclosure provides techniques for a two-step UE assisted CB mapping adaptation. In a first step, the UE may indicate, using periodic reporting, that the UE would prefer a different CB mapping type. In a second step, the base station may trigger an aperiodic CSI report for the UE to report CSI for the preferred CB mapping type. In some implementations, the periodic reporting may include a one-bit indicator of whether a different CB mapping type is preferred. As such, the one-bit indicator may not significantly increase the overhead of periodic reporting. The aperiodic CSI report may be an extended CB mapping report configured to provide an explicit CB mapping recommendation and corresponding channel state feedback. In some implementations, the aperiodic CSI report may include CSI for multiple CB mapping types such that the network is able to select the best CB mapping type. Following these two steps, the benefits of CB mapping type reconfiguration can be quantified and compared to the currently used CB mapping type on the network side based on the information provided by the extended CB mapping and CSF report such that NW can decide on CB mapping type reconfiguration. For example, the network may keep using the same CB mapping type or change to the CB mapping type recommended by the UE. In implementations where the extended CB mapping and CSF report includes information for multiple CB mapping types, the network may have a scheduling portfolio for different scheduling scenarios.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

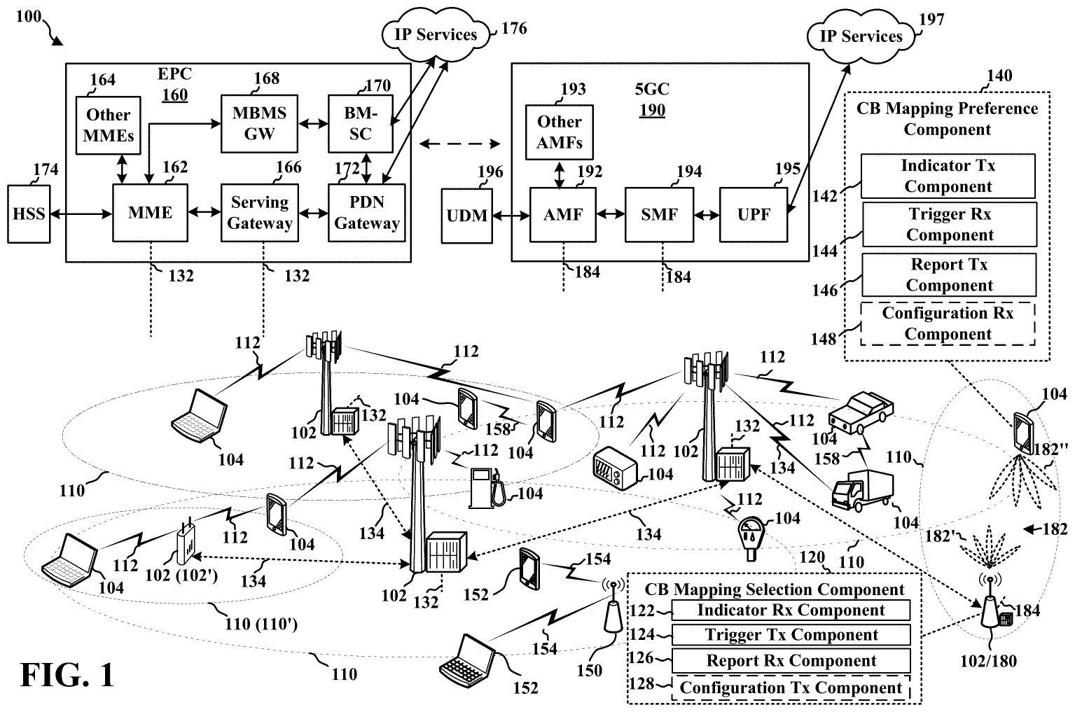

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network (e.g., a 5G Core (5GC) 190). The base stations 102 may include macrocells (high power cellular base station) and/or small cells (low power cellular base station). The macrocells include base stations. The small cells include femtocells, picocells, and microcells.

One or more of the UEs 104 may include a CB mapping preference component 140 configured to perform a two-step CB mapping recommendation. The CB mapping preference component 140 may include an indicator Tx component 142 configured to transmit an indicator that a recommended CB mapping type is preferred by the UE over a current CB mapping type. The CB mapping preference component 140 may include trigger Rx component 144 configured to receive a trigger of an aperiodic channel state information (CSI) report associated with CB mapping information. The CB mapping preference component 140 may include a report Tx component 146 configured to transmit the aperiodic CSI report for one or more CB mapping types in response to the trigger. In some implementations, the CB mapping preference component 140 may optionally include a configuration Rx component 148 configured to receive a configuration of CB mapping types for the UE, a configuration of the aperiodic CSI report, or an activation of one CSI trigger state of a plurality of CSI trigger states for the aperiodic CSI report.

In an aspect, one or more of the base stations 102 may include a CB mapping selection component 120 that performs the actions of the base station as described herein (e.g., performing a two-step dynamic CB mapping adaptation). For example, the CB mapping selection component 120 may include an indicator Rx component 122 configured to receive an indicator that a recommended CB mapping type is preferred by a UE over a current CB mapping type for the UE. The CB mapping selection component 120 may include a trigger Tx component 124 configured to transmit a trigger of an aperiodic CSI report associated with CB mapping information. The CB mapping selection component 120 may include a report Rx component 126 configured to receive the aperiodic CSI report for one or more CB mapping types in response to the trigger. In some implementations, the CB mapping selection component 120 may optionally include a configuration Tx component 128 configured to transmit a configuration of CB mapping types for the UE, a configuration of the aperiodic CSI report, or an activation of one CSI trigger state of a plurality of CSI trigger states for the aperiodic CSI report.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The backhaul links 132 may be wired or wireless. The base stations 102 configured for 5G NR (collectively referred to as Next Generation RAN (NG-RAN)) may interface with 5GC 190 through backhaul links 184. The backhaul links 184 may be wired or wireless. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 112 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 112 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and a physical sidelink feedback channel (PSFCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

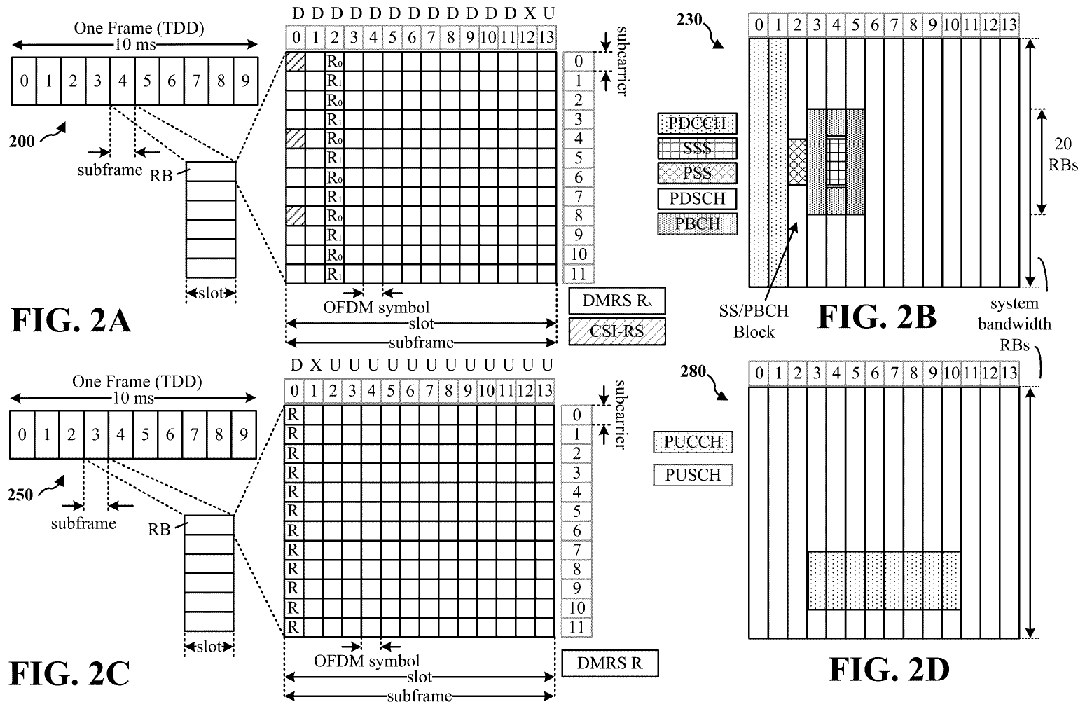

FIGS. 2A-2D are resource diagrams illustrating example frame structures and channels that may be used for uplink, downlink, and sidelink transmissions to a UE 104 including a CB mapping preference component 140. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0), each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz, and the numerology μ=5 has a subcarrier spacing of 480 KHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

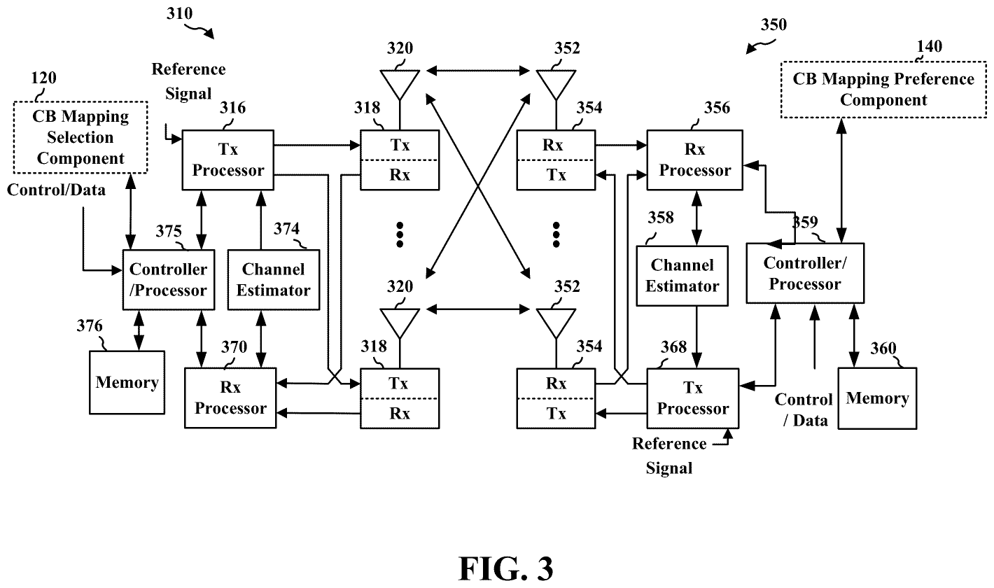

FIG. 3 is a block diagram of a base station 310 in communication with a UE 350 in an access network. In the DL. IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate an RF carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160 or 5GC 190. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the CB mapping preference component 140 of FIG. 1.

At least one of the Tx processor 316, the Rx processor 370, and the controller/processor 375 may be configured to perform aspects in connection with the CB mapping selection component 120 of FIG. 1.

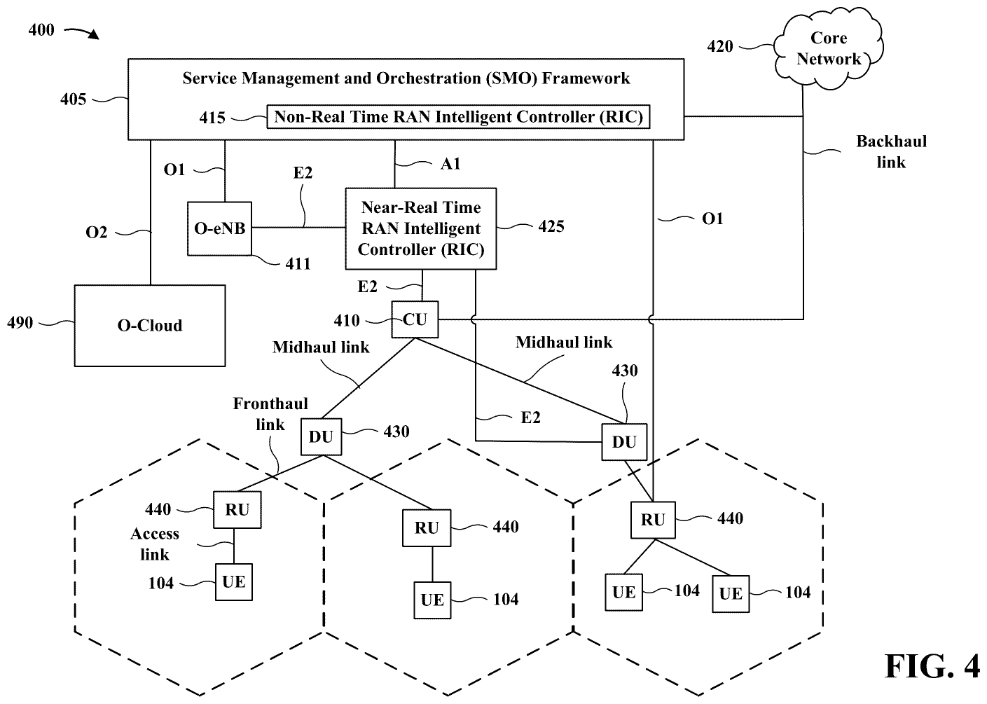

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUS) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUS 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

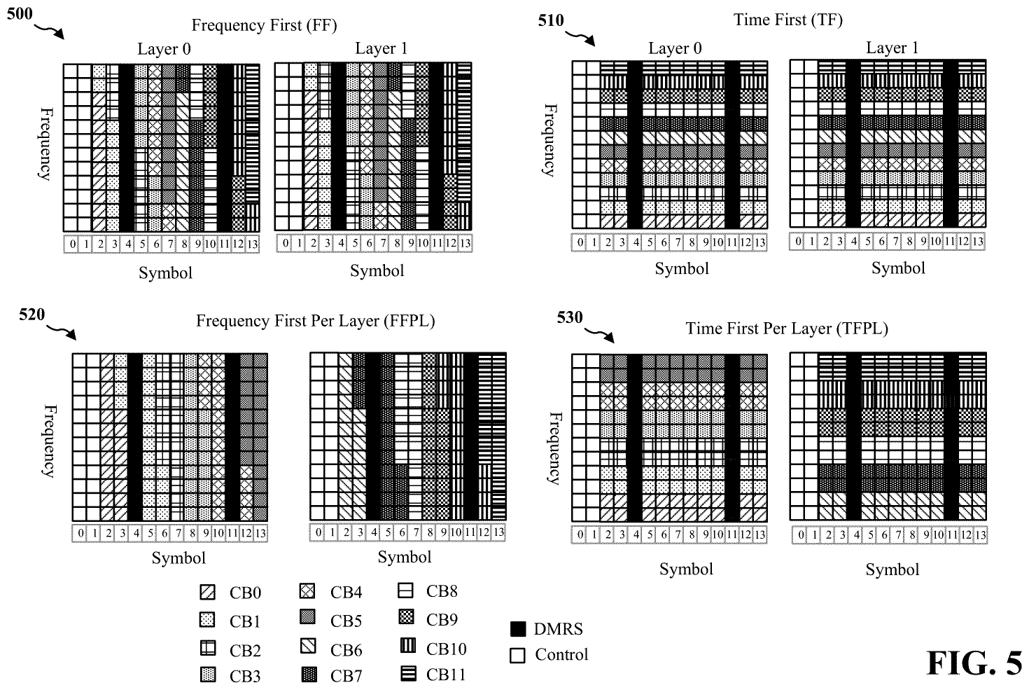

FIG. 5 is a diagram illustrating various CB to RE mapping types. The examples are illustrated for two layers but may be extended to additional layers. A frequency first (FF) CB mapping type 500 maps the CBs across both layers in increasing frequency, then move to the next time-domain OFDM symbol. The time first (TF) CB mapping type 510 maps the CBs across available time-domain OFDM symbols first, then in increasing frequency. The frequency first per layer (FFPL) CB mapping type 520 maps the CBs in layer 0 in the frequency first order, then maps the CBs in layer 1. The time first per layer (TFPL) CB mapping type 530 maps the CBs in layer 0 in the time first order, then maps the CBs in layer 1.

As discussed above, the various CB to RE mapping types may provide better decoding performance in various scenarios. Generally, the performance differences may be due to different types of diversity provided by each mapping type. Time diversity may be enhanced or exploited when every CB is spanned across multiple OFDM symbols. Enhanced time diversity may be beneficial for scenarios with a relatively low time coherency of the channel (high Doppler spread) or in case that the channel estimation error is not equal for all the data OFDM symbols of the allocation. For example, channel estimation error may be significantly higher for the edge OFDM symbols of the allocation due to channel estimation extrapolation. Frequency diversity may be enhanced or exploited when CBs are spanning across multiple RBs. Enhanced frequency diversity may be beneficial for scenarios with a relatively low channel coherency bandwidth (mid/high delay spread). Spatial or layer diversity (relevant only for the case of MIMO with rank>1) is enhanced or exploited when every CB is spanned across multiple layers. Enhanced spatial or layer diversity is desired as the imbalance between layers increases. For example. FF CB mapping type 500 provides frequency and spatial diversity for each CB, while TF CB mapping type 510 provides time diversity and spatial diversity. The FFPL CB mapping type 520 and the TFPL mapping type 530 provide less spatial diversity but greater frequency and time diversity, respectively.

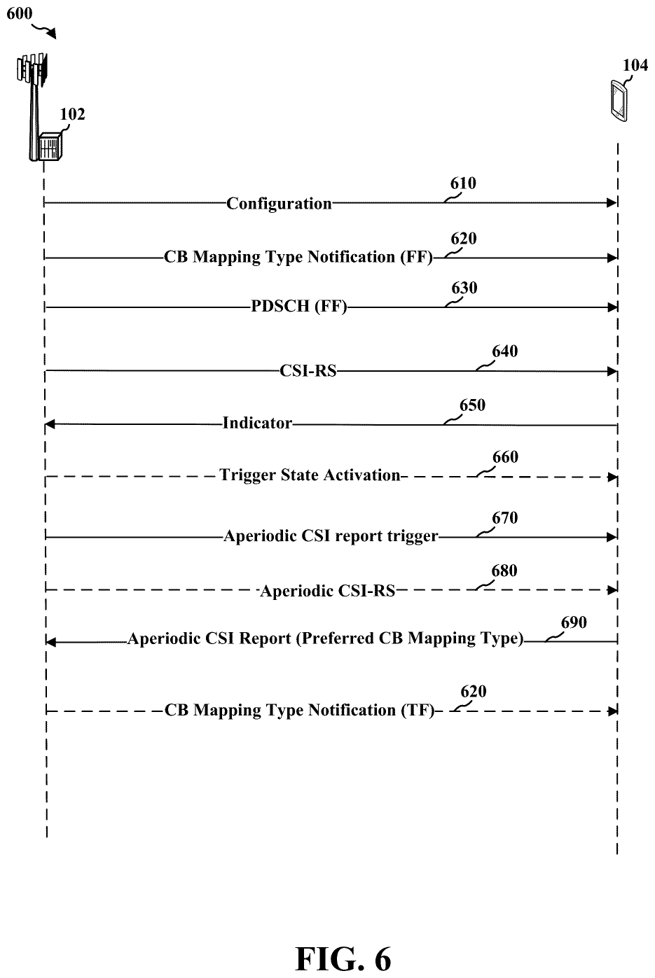

FIG. 6 is a message diagram 600 illustrating example messages for a two-step UE assisted dynamic CB mapping adaptation. A base station 102 may transmit a configuration message 610 that may configure a UE for dynamic CB mapping and/or CSI reporting. For example, the configuration message 610 may be a radio resource control (RRC) message. The configuration message 610 may include a configuration of CB mapping types for the UE. For instance, the configuration message 610 may configure a subset of the CB mapping types 500, 510, 520, 530 and/or other CB mapping types. The configuration message 610 may include a configuration of one or more aperiodic CSI report. For example, an aperiodic CSI report configuration may associate a subset of CB mapping types with an identifier of the aperiodic CSI report. In some implementations, the configuration of the aperiodic CSI report may include multiple trigger states. Each trigger state may be associated with one or more CB mapping types. In some implementations, an activation of a trigger state may dynamically associate the aperiodic CSI report with the CB mapping type.

The base station 102 may signal a current dynamic CB mapping type by transmitting a CB mapping type notification 620. As illustrated, the current dynamic CB mapping type may be FF CB mapping type 500, for example. The CB mapping type notification 620 may be signaled via a media access control (MAC) control element (CE) or via downlink control information (DCI). Generally, a CB mapping type notification 620 transmitted as a MAC-CE may be applicable until the current dynamic CB mapping type is changed by another MAC-CE. A CB mapping type notification 620 transmitted as a DCI may indicate a dynamic CB mapping type to use for one or more transmissions scheduled by the DCI. The use of the DCI to signal CB mapping type may allow per allocation variations of the CB mapping type selected by the network.

The base station 102 may transmit a PDSCH 630 according to the current CB mapping type. As illustrated, the current CB mapping type may initially be the FF CB mapping type 500. The UE 104 may receive the PDSCH 630 according to the CB mapping type indicated by the CB mapping type notification 620. The base station 102 may transmit a CSI-RS 640 or other reference signals. The UE 104 may use the CSI-RS 640 or other reference signals to perform measurements.

The UE may determine that the current CB mapping type is not preferred based on one or more metrics. Example metrics include: CSI-RS measurements; tracking reference signal (TRS) measurements; channel correlation in time and frequency with received signal to noise ratio (SNR) measurements; estimation of decoding probability for each CB based on past allocations; deviations in decoding probability between different CBs of a transport block; differences in retransmissions per CB; differences in an average number of LDPC decoding iterations per CB; information regarding UE impairments; or CB grouping enablement status and number of code block groups. In some implementations, a machine-learning model may be trained to classify one or more metrics into a preferred CB mapping type. For example, the machine-learning model may be trained locally for the UE or by a machine-learning network element. For instance, the UE may collect training data including sets of any of the above UE metrics, current CB mapping type, and a performance metric such as throughput or CB decoding rate. The machine-learning model may receive the UE metrics as input and select a CB mapping type to optimize the predicted performance metric.

The UE 104 may transmit an indicator 650 when the current CB mapping type is not the preferred CB mapping type (e.g., based on the metric). The indicator 650 may indicate that a recommended CB mapping type is preferred by the UE over a current CB mapping type. For example, the indicator 650 may be transmitted within uplink control information (UCI), which may be transmitted on a PUCCH or PUSCH. The indicator 640 may indicate that a second CB mapping type is preferred by the UE 104. In some implementations, the indicator 650 may be a one-bit indicator that requests to change from the current CB mapping type. The one-bit indicator may implicitly recommend a different CB mapping type. In some implementations, the indicator 650 may be a two-bit indicator that explicitly recommends one of up to four configured CB mapping types. For instance, the UE may be configured by the configuration message 610 with up to four CB mapping types such as FF CB mapping type 500, TF CB mapping type 510, FFPL CB mapping type 520, and/or TFPL CB mapping type 530. The two-bit indicator may correspond to an index of a configured mapping type.

In some implementations, the indicator 650 may be signaled (or reported) coupled to a CSI report. For example, the indicator 650 may be an additional component in UCI including a CSI report or may be a part of a new extended CSI report format that includes an additional one-bit or two-bit field dedicated to the indicator 650. The CSI report may be a periodic CSI report or a semi-persistent CSI report. In some implementations, a one-bit or two-bit indicator 650 coupled with the periodic CSI report or semi-persistent CSI report to provide information with low overhead. The indicator 650 may indicate that the recommended CB mapping type is preferred over the current CB mapping type on which the CSI report is based. In some implementations, the indicator 650 may be signaled in UCI and not coupled to any CSI report. For example, the indicator 650 may be transmitted in a UCI including HARQ ACK/NAK. For instance, in cases where the metric is based on decoding probability or retransmission rate, the indicator 650 may not be coupled with a CSI report.

In response to the indicator 650 from the UE, the network (e.g., base station 102) may request an aperiodic CSI report 690 from the UE 104. In some implementations, the base station 102 may transmit a trigger state activation 660 to activate a configured trigger state associated with one or more CB mapping types. The trigger state activation 660 may be transmitted as a MAC-CE. The base station 102 may transmit an aperiodic CSI report trigger 670 to initiate the aperiodic CSI report. The aperiodic CSI report trigger 670 may include an identifier of a configured aperiodic CSI report. In some implementations, the configured aperiodic CSI report may be configured with a field for indicating the preferred CB mapping type. In some implementations, the identifier of the configured aperiodic CSI report and/or the active trigger state of the configured aperiodic CSI report may identify a CB mapping type to use for the aperiodic CSI report 690.

The UE 104 may generate the aperiodic CSI report 690 to include information for one or more CB mapping types. That is, because the CB mapping type affects the decoding performance of the UE, the contents of the CSI such as CQI and RI may depend on the CB mapping type. Accordingly, for the aperiodic CSI report, the UE 104 may assume the preferred CB mapping type or an indicated CB mapping type when calculating the CSI. In some implementations, the base station 102 may transmit an aperiodic CSI-RS 680 for the UE 104 to use when calculating the CSI. The UE 104 may transmit the aperiodic CSI report 690 as UCI as scheduled by the aperiodic CSI report trigger 670.

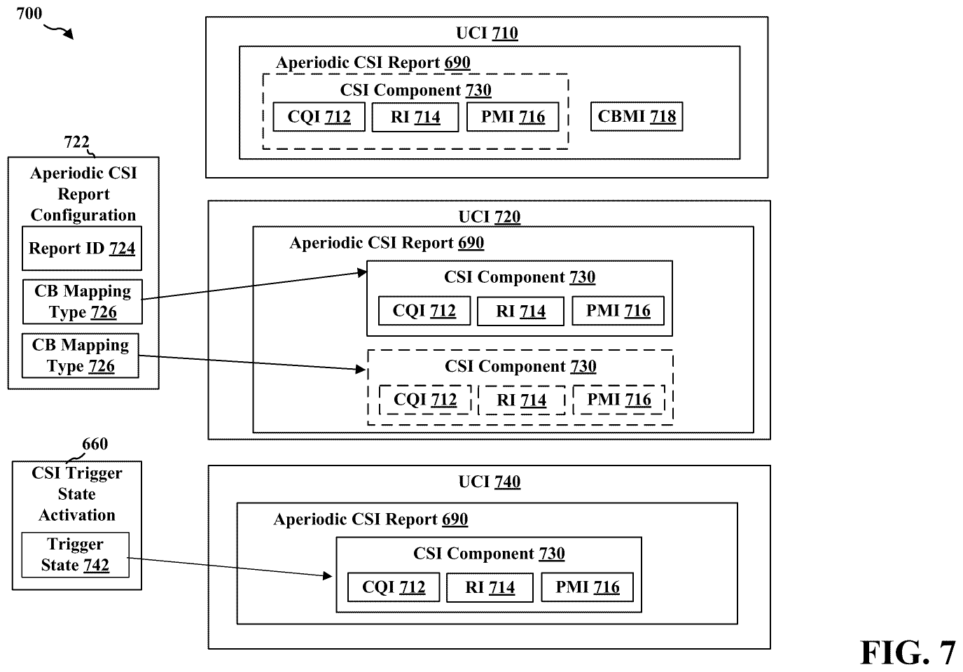

The base station 102 may optionally signal a change to the CB mapping type by transmitting a new CB mapping type notification 620. For instance, as illustrated, the base station 102 may change the CB mapping type to the TF CB mapping type 510. The base station 102 may consider the aperiodic CSI report 690 as well as other information such as a scheduling scenario. CSI based on a CSI report or SRS, operational MCS and RI, channel delay spread. Doppler spread. SNR measurements, and/or UE speed. Some of these considerations may involve additional information provided by the UE 104. FIG. 7 is a diagram 700 of example UCI formats for the aperiodic CSI report 690. In a first example, a UCI 710 may include an aperiodic CSI report 690 with an extended report quantity. For example, the configuration message 610 may configure the aperiodic CSI report 690 using a reportQuantity information element (IE) that specifies the contents of the CSI report. For example, the reportQuantity IE may indicate a code block mapping index (CBMI) 720 that identifies the preferred CB mapping type based on the configured CB mapping types for the UE. In some implementations, the CBMI 718 may be grouped with conventional CSI parameters such as CQI 712, RI 714, and PMI 716, although other sets of parameters may be configured. The presence of the CBMI 718 may allow the base station to identify the preferred CB mapping type. The CQI 712, RI 714, and PMI 716 may be based on a CSI reference resource assumption according to the preferred CB mapping type indicated by the CBMI 718.

In a second example, a UCI 720 may include one or more CSI components 730 based on a configuration 722 of the aperiodic CSI report 690 indicated by a CSI report ID signaled in the aperiodic CSI report trigger 670. The configuration message 610 may define the configuration 722 to associate the CSI report ID 724 with one or more of the configured CB mapping types 726. The number of CSI components 730 may be equal to the number of configured CB mapping types for the configuration 722. The CSI components 730 may include the CSI parameters indicated by the report quantity such as CQI 712, RI 714, and PMI 716. The UCI 720 may not explicitly indicate the CB mapping type for each CSI component 730 because the CSI components 730 may be included in the order configured by the aperiodic CSI report configuration 722. The CSI reference resource assumption for each CSI component 730 may be based on the corresponding CB mapping type. The availability of multiple CSI components 730 may allow the network to rank CB mapping types and/or select CB mapping type based on scheduling scenario and/or allocation size.

In a third example, a UCI 740 may include one or more CSI components 730 corresponding to a trigger state 742 indicated by a CSI trigger state activation 660. The UCI 720 may not explicitly indicate the CB mapping type for each CSI component 730 because the CSI components 730 may be included in the order configured for the trigger state 742. The network may select the CSI trigger state activation 660 based on the indicator 650. In particular, where the indicator 650 is a two-bit indicator or explicit indicator of a preferred mapping type, the base station 102 may transmit a CSI trigger state activation 660 that activates a trigger state 742 associated with the preferred CB mapping type. Accordingly, the base station may dynamically configure the UE 104 to report a CSI component 730 for the preferred CB mapping type. For the third example, the configuration message 610 may include a configuration of multiple trigger states for an aperiodic CSI report, each trigger state being associated with one or more CB mapping types. The CSI reference resource assumption for the CSI component 730 may be based on the CB mapping type associated with the active trigger state.

The UE 104 may make the following additional assumptions about the CSI reference resource: The first 2 OFDM symbols are occupied by control signaling; the number of PDSCH and DM-RS symbols is equal to 12; the same bandwidth part subcarrier spacing configured as for the PDSCH reception; the bandwidth as configured for the corresponding CQI report; the reference resource uses the CP length and subcarrier spacing configured for PDSCH reception; no resource elements used by primary or secondary synchronization signals or PBCH; The redundancy version is 0; the ratio of PDSCH EPRE to CSI-RS EPRE is as given in Subclause 4.1; no REs are allocated for NZP CSI-RS and ZP CSI-RS; the same number of front loaded DM-RS symbols as the maximum front-loaded symbols configured by the higher layer parameter maxLength in DMRS-DownlinkConfig; the number of additional DM-RS symbols is the same as the additional symbols configured by the higher layer parameter dmrs-AdditionalPosition; the PDSCH symbols do not contain DM-RS; and the PRB bundling size is 2 PRBs.

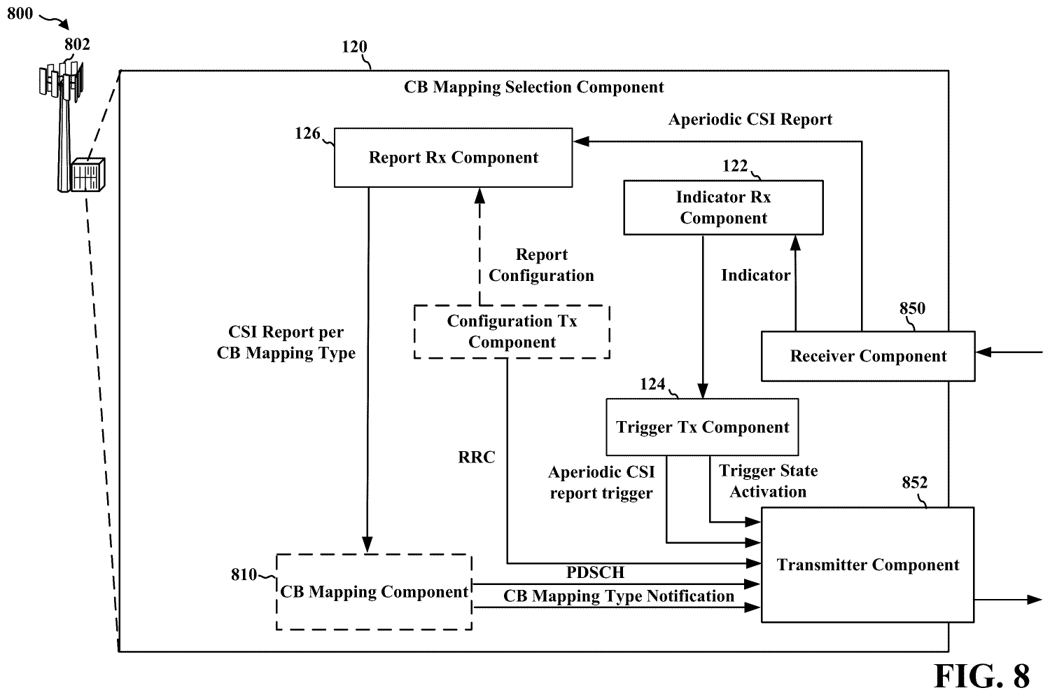

FIG. 8 is a conceptual data flow diagram 800 illustrating the data flow between different means/components in an example base station 802, which may be an example of the base station 102 including the CB mapping selection component 120. The CB mapping selection component 120 may include the indicator Rx component 122, the trigger Tx component 124, the report Rx component 126. The CB mapping selection component 120 may optionally include the configuration Tx component 128. The CB mapping selection component 120 may optionally include a CB mapping component 810.

The base station 802 may also include a receiver component 850 and a transmitter component 852. The receiver component 850 may include, for example, a RF receiver for receiving the signals described herein. The transmitter component 852 may include for example, an RF transmitter for transmitting the signals described herein. In some implementations, the receiver component 850 and the transmitter component 852 may be co-located in a transceiver such as the Tx/Rx 318 in FIG. 3.

The receiver component 850 may receive uplink signals from UEs 104. For example, the receiver component 850 may receive the indicator 650 or the aperiodic CSI report 690. The receiver component 850 may provide the indicator 650 to the indicator Rx component 122. The receiver component 850 may provide the aperiodic CSI report to the report Rx component 126.

In some implementations, the configuration Tx component 128 may be configured to transmit a configuration for dynamic CB mapping and/or CSI reporting for a UE. For example, the configuration Tx component 128 may transmit the configuration message 610, which may include a CB mapping type configuration and/or an aperiodic CSI report configuration 722. The aperiodic CSI report configuration 722 may include a configuration of the trigger states 742. The configuration Tx component 128 may transmit the configuration message 610 as an RRC message via the transmitter component 852.

The indicator Rx component 122 may be configured to receive the indicator 650. The indicator Rx component 122 may receive the indicator 650 via the receiver component 850. For example, the indicator Rx component 122 may receive the indicator 650 as UCI. For instance, the indicator 650 may be attached to a periodic CSI report or HARQ ACK/NAK feedback. The indicator Rx component 122 may provide an indicator signal to the trigger Tx component 124. In implementations where the indicator 650 identifies the preferred CB mapping type, the indicator Rx component 122 may provide the preferred CB mapping type to the trigger Tx component 124.

The trigger Tx component 124 may be configured to transmit a trigger of an aperiodic CSI report associated with CB mapping information. The trigger Tx component 124 may receive the indicator signal and/or preferred CB mapping type from the indicator Rx component 122. The trigger Tx component 124 may transmit the aperiodic CSI report trigger 670 in response to the indicator signal. In some implementations, prior to transmitting the aperiodic CSI report trigger 670, the trigger Tx component 124 may select a trigger state based on the indicator signal and/or the preferred CB mapping type. For example, the trigger Tx component 124 may select a trigger state that is not associated with the current CB mapping type in response to the indicator or may select a trigger state associated with the preferred CB mapping type. The trigger Tx component 124 may transmit the trigger state activation 660 including the selected trigger state.

The report Rx component 126 may be configured to receive the aperiodic CSI report for one or more CB mapping types in response to the trigger. The report Rx component 126 may receive the aperiodic CSI report 690 via the receiver component 850. The report Rx component 126 may receive the report configuration from the configuration Tx component 128. The report Rx component 126 may determine the CB mapping type associated with a received aperiodic CSI report 690 or a CSI component 730 included therein based on the report configuration. For example, for the UCI 710, the report Rx component 126 may identify the preferred CB mapping type based on the CBMI 718. For the UCI 720, the report Rx component 126 may identify the CB mapping type 726 based on the aperiodic CSI report configuration 722. For the UCI 740, the report Rx component 126 may identify the CB mapping type based on the trigger state 742. The report Rx component 126 may provide a CSI report per CB mapping type to the CB mapping component 810.

The CB mapping component 810 may be configured to transmit a PDSCH based on a dynamically selected CB mapping type in one or more slots. The CB mapping component 810 may select the CB mapping type based at least in part on the CSI report per CB mapping type from the report Rx component 126. The CB mapping component 810 may consider one or more of a scheduling scenario, the CSI, downlink operational MCS and RI, channel delay spread, Doppler spread measurements, SNR measurements, reported UE speed, or reported UE Doppler measurements. The CB mapping component 810 may transmit the CB mapping type notification indicating the selected CB mapping type via the transmitter component 852. The CB mapping component 810 may receive the CBs for the PDSCH from higher layers (e.g., an encoder). The CB mapping component 810 may map the CBs to REs according to the dynamic CB mapping type, for example, as illustrated in FIG. 5. The CB mapping component 810 may transmit the PDSCH via the transmitter component 852.

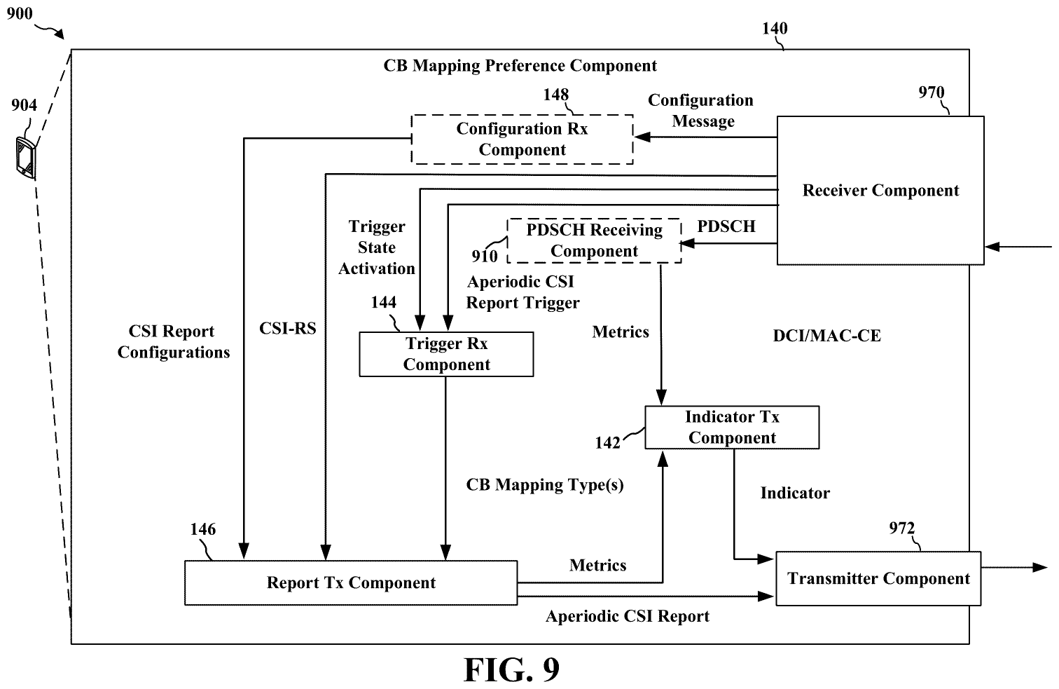

FIG. 9 is a conceptual data flow diagram 900 illustrating the data flow between different means/components in an example UE 904, which may be an example of the UE 104 and include the CB mapping preference component 140. As discussed with respect to FIG. 1, the CB mapping preference component 140 may include the indicator Tx component 142, the trigger Rx component 144, the report Tx component 146. The CB mapping preference component 140 may optionally include the configuration Rx component 148. The CB mapping preference component 140 may optionally include a PDSCH receiving component 910.

The UE 904 also may include a receiver component 970 and a transmitter component 972. The receiver component 970 may include, for example, a RF receiver for receiving the signals described herein. The transmitter component 972 may include for example, an RF transmitter for transmitting the signals described herein. In some implementations, the receiver component 970 and the transmitter component 972 may be co-located in a transceiver such as the Tx/Rx 354 in FIG. 3.

The receiver component 970 may receive downlink signals such as the configuration message 610, the CB mapping type notification 620, the PDSCH 630, the CSI-RS 640, the trigger state activation 660, or the aperiodic CSI report trigger 670. The receiver component 970 may provide the configuration message 610 to the configuration Rx component 148. The receiver component 970 may provide the CB mapping type notification 620 and/or the PDSCH 630 to the PDSCH receiving component 910. The receiver component 970 may provide the CSI-RS to the report Tx component 146. The receiver component 970 may provide the trigger state activation 660 and/or the aperiodic CSI report trigger 670 to the trigger Rx component 144.

The configuration Rx component 148 may be configured to receive a configuration for dynamic CB mapping and/or CSI reporting. The configuration Rx component 148 may receive the configuration message 610 via the receiver component 970. The configuration Rx component 148 may determine the set of CB mapping types 500, 510, 520, 530 configured for the UE 904. The configuration Rx component 148 may determine one or more aperiodic CSI report configurations 722 associated with CB mapping types. In some implementations, a CSI report configurations 722 may include a trigger state 742 associated with at least one CB mapping type. The configuration Rx component 148 may provide the aperiodic CSI report configurations to the report Tx component 146.

In some implementations, the PDSCH receiving component 910 may be configured to receive a PDSCH based on a dynamic CB mapping type in one or more slots. For example, the PDSCH receiving component 910 may receive the PDSCH 630 via the receiver component 970. In some implementations, the PDSCH receiving component 910 may receive the CB mapping type notification 620 via the receiver component 970. The PDSCH receiving component 910 may decode a received PDSCH based on the dynamic CB mapping type indicated by the CB mapping type notification 620. The PDSCH receiving component 142 may demap the REs of the PDSCH to the CBs, then decode each CB separately. In some implementations, the PDSCH receiving component 910 may generate metrics based on the received PDSCH and provide the metrics to the indicator Tx component 142.

The indicator Tx component 142 may be configured to transmit an indicator that a recommended CB mapping type is preferred by the UE over a current CB mapping type. In some implementations, the indicator Tx component 142 may receive metrics from the PDSCH receiving component 910. In some implementations, the indicator Tx component 142 may receive metrics from the report Tx component 146. The indicator Tx component 142 may determine the recommended CB mapping type based on the metrics. The indicator Tx component 142 may transmit the indicator 650 via the transmitter component 972.

The trigger Rx component 144 may be configured to receive a trigger of an aperiodic CSI report associated with CB mapping information. The trigger Rx component 144 may receive the aperiodic CSI report trigger 670 via the receiver component 970. In some implementations, the trigger Rx component 144 may receive a trigger state activation 660 via the receiver component 970. The trigger Rx component 144 may determine one or more CB mapping types based on the aperiodic CSI report trigger 670, the trigger state activation 660, and/or a CSI report configuration. The trigger state Rx component 144 may provide the CB mapping types to the report Tx component.

The report Tx component 146 may be configured to transmit the aperiodic CSI report for one or more CB mapping types in response to the trigger. The report Tx component 146 may receive the indication of the trigger and the CB mapping types from the trigger Rx component 144. The report Tx component 146 may receive the CSI-RS 640 and/or the aperiodic CSI-RS 680 via the receiver component 970. The report Tx component 146 may receive the CSI report configurations from the configuration Rx component. The report Tx component 146 may calculate the CSI (e.g., CQI 812 and RI 814) based on the CSI-RS 640 and/or the aperiodic CSI-RS 680 and the CB mapping type assumption indicated by the trigger Rx component 144. The report Tx component 146 may format the aperiodic CSI report 690 based on the CSI report configuration. The report Tx component 146 may transmit the aperiodic CSI report 690 via the transmitter component 972.

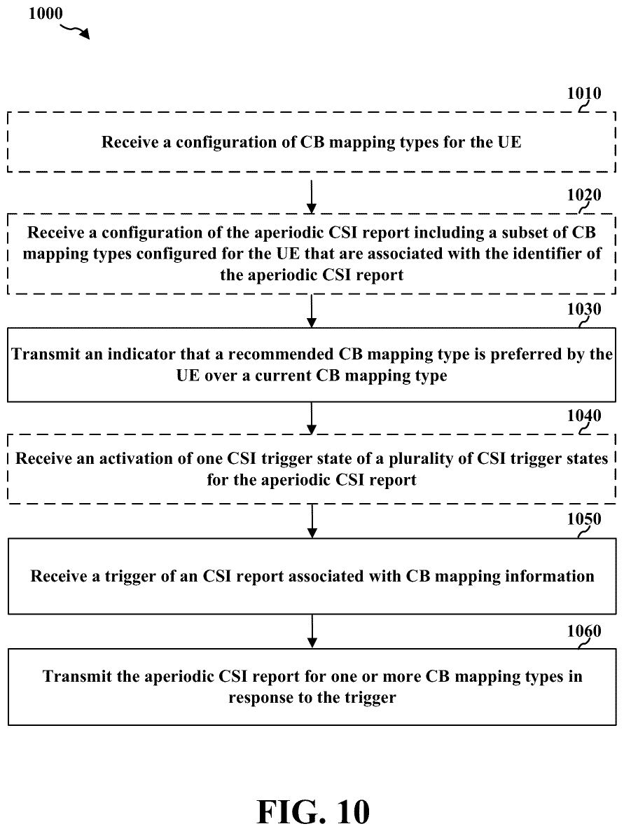

FIG. 10 is a flowchart of an example method 1000 for a UE to perform a two-step recommendation for dynamic CB mapping. The method 1000 may be performed by a UE (such as the UE 104, which may include the memory 360 and which may be the entire UE 104 or a component of the UE 104 such as the CB mapping preference component 140, Tx processor 368, the Rx processor 356, or the controller/processor 359). The method 1000 may be performed by the CB mapping preference component 140 in communication with the CB mapping selection component 120 of the base station 102. Optional blocks are shown with dashed lines.

At block 1010, the method 1000 optionally includes receiving a configuration of CB mapping types for the UE. In some implementations, for example, the UE 104, the Rx processor 356, or the controller/processor 359 may execute the CB mapping preference component 140 or the configuration Rx component 148 to receive the configuration message 610 including configuration of CB mapping types for the UE. Accordingly, the UE 104, the Rx processor 356, or the controller/processor 359 executing the CB mapping preference component 140 or the configuration Rx component 148 may provide means for receiving a configuration of CB mapping types for the UE.

At block 1020, the method 1000 optionally includes receiving a configuration of an aperiodic CSI report including a subset of CB mapping types configured for the UE that are associated with the identifier of the aperiodic CSI report. In some implementations, for example, the UE 104, the Rx processor 356, or the controller/processor 359 may execute the CB mapping preference component 140 or the configuration Rx component 148 to receive the configuration message 610 including the configuration 722 of the aperiodic CSI report including a subset of CB mapping types 726 configured for the UE that are associated with the identifier 724 of the aperiodic CSI report. Accordingly, the UE 104, the Rx processor 356, or the controller/processor 359 executing the CB mapping preference component 140 or the configuration Rx component 148 may provide means for receiving a configuration of the aperiodic CSI report including a subset of CB mapping types configured for the UE that are associated with the identifier of the aperiodic CSI report.

At block 1030, the method 1000 includes transmitting an indicator that a recommended CB mapping type is preferred by the UE over a current CB mapping type. In some implementations, for example, the UE 104, the Tx processor 368, or the controller/processor 359 may execute the CB mapping preference component 140 or the indicator Tx component 142 to transmit the indicator 650 that a recommended CB mapping type is preferred by the UE 104 over a current CB mapping type. In some implementations, the indicator 650 identifies the recommended CB mapping type. For example, the indicator 650 may be a two-bit indication identifying an index of a configured CB mapping type. Accordingly, the UE 104, the Tx processor 368, or the controller/processor 359 executing the CB mapping preference component 140 or the indicator Tx component 142 may provide means for transmitting an indicator that a recommended CB mapping type is preferred by the UE over a current CB mapping type.

At block 1040, the method 1000 optionally includes receiving an activation of one CSI trigger state of a plurality of CSI trigger states for the aperiodic CSI report. In some implementations, for example, the UE 104, the Rx processor 356, or the controller/processor 359 may execute the CB mapping preference component 140 or the trigger Rx component 144 to receive the activation 660 of one CSI trigger state 742 of a plurality of CSI trigger states for the aperiodic CSI report 690. The CSI trigger state 742 is associated with at least one CB mapping type for the aperiodic CSI report 690. Accordingly, the UE 104, the Rx processor 356, or the controller/processor 359 executing the CB mapping preference component 140 or the trigger Rx component 144 may provide means for receiving an activation of one CSI trigger state of a plurality of CSI trigger states for the aperiodic CSI report.

At block 1050, the method 1000 includes receiving a trigger of an aperiodic CSI report associated with CB mapping information. In some implementations, for example, the UE 104, the Rx processor 356, or the controller/processor 359 may execute the CB mapping preference component 140 or the trigger Rx component 144 to receive the trigger 670 of the aperiodic CSI report 690 associated with CB mapping information. Accordingly, the UE 104, the Rx processor 356, or the controller/processor 359 executing the CB mapping preference component 140 or the configuration Rx component 148 may provide means for receiving a trigger of an aperiodic CSI report associated with CB mapping information.

At block 1060, the method 1000 includes transmitting the aperiodic CSI report for one or more CB mapping types in response to the trigger. In some implementations, for example, the UE 104, the Tx processor 368, or the controller/processor 359 may execute the CB mapping preference component 140 or the report Tx component 146 to transmit the aperiodic CSI report 690 for one or more CB mapping types in response to the trigger. In some implementations, the aperiodic CSI report 690 includes an identifier of the recommended CB mapping type (e.g., CBMI 718) and a corresponding CSI component 730 based on the CB mapping type. For example, the aperiodic CSI report may include the identifier of the recommended CB mapping type, a rank indicator, a precoding matrix indicator, and a channel quality indicator. In some implementations, the aperiodic CSI report 690 includes a plurality of CSI components 730, each CSI component 730 based on a respective CB mapping type 726 associated with an identifier 724 of the aperiodic CSI report 690. Each CSI component may be based on a CSI reference resource assumption corresponding to the respective CB mapping type. In some implementations, the at least one CSI component 730 is based on a CSI reference resource assumption corresponding to the at least one CB mapping type for the aperiodic CSI report indicated by the trigger state 742. Accordingly, the UE 104, the Tx processor 368, or the controller/processor 359 executing the CB mapping preference component 140 or the report Tx component 146 may provide means for transmitting the aperiodic CSI report for one or more CB mapping types in response to the trigger.

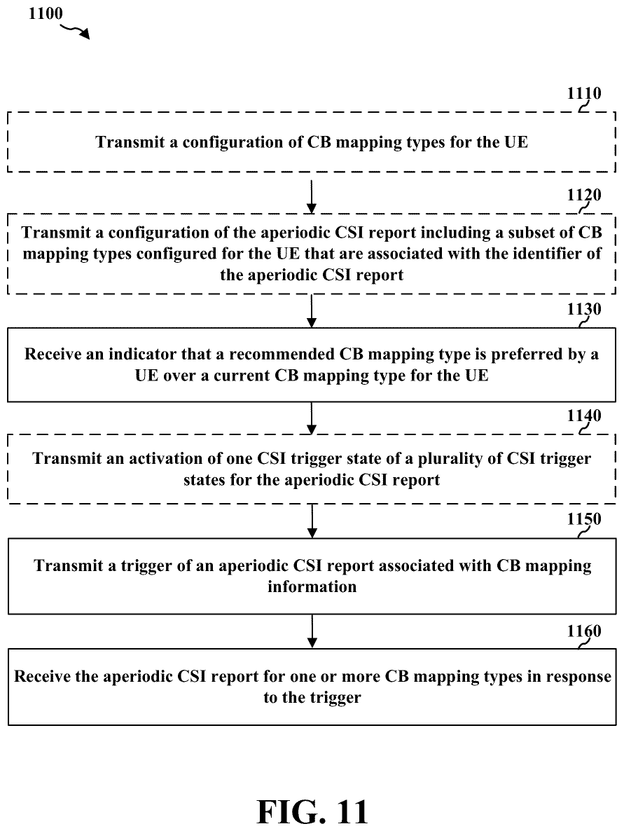

FIG. 11 is a flowchart of an example method 1100 for a base station to perform a two-step UE assisted dynamic CB mapping adaptation. The method 1100 may be performed by a base station (such as the base station 102, which may include the memory 376 and which may be the entire base station 102 or a component of the base station 102 such as the CB mapping selection component 120, Tx processor 316, the Rx processor 370, or the controller/processor 375). The method 1100 may be performed by the CB mapping selection component 120 in communication with the CB mapping preference component 140 of the UE 104.

At block 1110, the method 1100 optionally includes transmitting a configuration of the aperiodic CSI report including a subset of CB mapping types configured for the UE that are associated with the identifier of the aperiodic CSI report. In some implementations, for example, the base station 102, Tx processor 316, or the controller/processor 375 may execute the CB mapping selection component 120 or the configuration Tx component 128 to transmit a configuration of the aperiodic CSI report including a subset of CB mapping types configured for the UE that are associated with the identifier of the aperiodic CSI report. Accordingly, the base station 102, Tx processor 316, or the controller/processor 375 executing the CB mapping selection component 120 or the configuration Tx component 128 may provide means for transmitting a configuration of the aperiodic CSI report including a subset of CB mapping types configured for the UE that are associated with the identifier of the aperiodic CSI report.

At block 1120, the method 1100 optionally includes transmitting a configuration of CB mapping types for the UE. In some implementations, for example, the base station 102, Tx processor 316, or the controller/processor 375 may execute the CB mapping selection component 120 or the configuration Tx component 128 to transmit the configuration of CB mapping types for the UE. Accordingly, the base station 102, Tx processor 316, or the controller/processor 375 executing the CB mapping selection component 120 or the configuration Tx component 128 may provide means for transmitting a configuration of CB mapping types for the UE.

At block 1130, the method 1100 includes receiving an indicator that a recommended CB mapping type is preferred by a UE over a current CB mapping type for the UE. In some implementations, for example, the base station 102, Rx processor 370, or the controller/processor 375 may execute the CB mapping selection component 120 or the indicator Rx component 122 to receive the indicator 650 that a recommended CB mapping type is preferred by the UE over a current CB mapping type for the UE. Accordingly, the base station 102, the Rx processor 370, or the controller/processor 375 executing the CB mapping selection component 120 or the indicator Rx component 122 may provide means for receiving an indicator that a recommended CB mapping type is preferred by a UE over a current CB mapping type for the UE.

At block 1140, the method 1100 optionally includes transmitting an activation of one CSI trigger state of a plurality of CSI trigger states for the aperiodic CSI report. In some implementations, for example, the base station 102, Tx processor 316, or the controller/processor 375 may execute the CB mapping selection component 120 or the trigger Tx component 124 to transmit the activation 660 of one CSI trigger state 742 of a plurality of CSI trigger states for the aperiodic CSI report. The CSI trigger state 742 is associated with at least one CB mapping type for the aperiodic CSI report 690. Accordingly, the base station 102, Tx processor 316, or the controller/processor 375 executing the CB mapping selection component 120 or the trigger Tx component 124 may provide means for transmitting an activation of one CSI trigger state of a plurality of CSI trigger states for the aperiodic CSI report.

At block 1150, the method 1100 includes transmitting a trigger of an aperiodic CSI report associated with CB mapping information. In some implementations, for example, the base station 102, Tx processor 316, or the controller/processor 375 may execute the CB mapping selection component 120 or the trigger Tx component 124 to transmit a trigger of an aperiodic CSI report associated with CB mapping information. Accordingly, the base station 102, Tx processor 316, or the controller/processor 375 executing the CB mapping selection component 120 or the trigger Tx component 124 may provide means for transmitting a trigger of an aperiodic CSI report associated with CB mapping information.

At block 1160, the method 1100 includes receiving the aperiodic CSI report for one or more CB mapping types in response to the trigger. In some implementations, for example, the base station 102, Rx processor 370, or the controller/processor 375 may execute the CB mapping selection component 120 or the report Rx component 126 to receive the aperiodic CSI report for one or more CB mapping types in response to the trigger. In some implementations, the aperiodic CSI report 690 includes an indicator of the recommended CB mapping type (e.g., CBMI 718) and a corresponding CSI component 730 based on the recommended CB mapping type. For example, the aperiodic CSI report may include the identifier of the recommended CB mapping type, a rank indicator, a precoding matrix indicator, and a channel quality indicator. In some implementations, the aperiodic CSI report 690 includes a plurality of CSI components 730, each CSI component 730 based on a respective CB mapping type 726 associated with an identifier 724 of the aperiodic CSI report 690. Each CSI component may be based on a CSI reference resource assumption corresponding to the respective CB mapping type. In some implementations, the at least one CSI component 730 is based on a CSI reference resource assumption corresponding to the at least one CB mapping type for the aperiodic CSI report indicated by the trigger state 742. Accordingly, the base station 102, the Rx processor 370, or the controller/processor 375 executing the CB mapping selection component 120 or the report Rx component 126 may provide means for receiving the aperiodic CSI report for one or more CB mapping types in response to the trigger.

### Some Further Example Clauses

Implementation examples are described in the following numbered clauses:
1. A method of wireless communication at a user equipment (UE), comprising:
   transmitting an indicator that a recommended CB mapping type is preferred by the UE over a current CB mapping type;
   receiving a trigger of an aperiodic channel state information (CSI) report associated with CB mapping information; and
   transmitting the aperiodic CSI report for one or more CB mapping types in response to the trigger.
2. The method of clause 1, wherein the aperiodic CSI report includes an identifier of the recommended CB mapping type and a corresponding CSI component based on the recommended CB mapping type.
3. The method of clause 2, wherein the aperiodic CSI report includes the identifier of the recommended CB mapping type, a rank indicator, a precoding matrix indicator, and a channel quality indicator.
4. The method of any of clauses 1-3, further comprising receiving a configuration of CB mapping types for the UE.
5. The method of any of clauses 1-4, wherein the aperiodic CSI report includes a plurality of CSI components, each CSI component based on a respective CB mapping type associated with an identifier of the aperiodic CSI report.
6. The method of clause 5, further comprising receiving a configuration of the aperiodic CSI report including a subset of CB mapping types configured for the UE that are associated with the identifier of the aperiodic CSI report.
7. The method of clause 5 or 6, wherein each CSI component is based on a CSI reference resource assumption corresponding to the respective CB mapping type.
8. The method of any of clauses 1-7, further comprising receiving an activation of one CSI trigger state of a plurality of CSI trigger states for the aperiodic CSI report, wherein the CSI trigger state is associated with at least one CB mapping type for the aperiodic CSI report, and wherein the CSI report includes at least one CSI component based on the at least one CB mapping type.
9. The method of clause 8, wherein the indicator identifies the recommended CB mapping type, and the one CSI trigger state is associated with the recommended CB mapping type.
10. The method of clause 8 or 9, wherein the at least one CSI component is based on a CSI reference resource assumption corresponding to the at least one CB mapping type for the aperiodic CSI report.
11. An apparatus for wireless communication for a user equipment (UE), comprising:
   a memory storing computer-executable instructions; and
   at least one processor coupled to the memory and configured to execute the computer-executable instructions to perform the method of any of clauses 1-10.
12. An apparatus for wireless communication for a user equipment (UE), comprising means for performing the method of any of clauses 1-10.
13. A non-transitory computer-readable medium storing computer executable code, the code when executed by a processor of a user equipment (UE) causes the processor to perform the method of any of clauses 1-10.
14. A method of wireless communication at a base station, comprising:
   receiving an indicator that a recommended CB mapping type is preferred by a user equipment (UE) over a current CB mapping type for the UE;
   transmitting a trigger of an aperiodic channel state information (CSI) report associated with CB mapping information; and
   receiving the aperiodic CSI report for one or more CB mapping types in response to the trigger.
15. The method of clause 14, wherein the aperiodic CSI report includes an indicator of the recommended CB mapping type and a corresponding CSI component based on the recommended CB mapping type.
16. The method of clause 15, wherein the aperiodic CSI report includes the indicator of the recommended CB mapping type, a rank indicator, a precoding matrix indicator, and a channel quality indicator.
17. The method of any of clauses 14-16, further comprising transmitting a configuration of CB mapping types for the UE.
18. The method of any of clauses 14-17, wherein the CSI report includes a plurality of CSI components, each CSI component based on a respective CB mapping type associated with an identifier of the aperiodic CSI report.
19. The method of clause 18, further comprising transmitting a configuration of the aperiodic CSI report including a subset of CB mapping types configured for the UE that are associated with the identifier of the aperiodic CSI report.
20. The method of clause 18 or 19, wherein each CSI component is based on a CSI reference resource assumption corresponding to the respective CB mapping type.
21. The method of any of clauses 14-20, further comprising transmitting an activation of one CSI trigger state of a plurality of CSI trigger states for the aperiodic CSI report, wherein the CSI trigger state is associated with at least one CB mapping type for the aperiodic CSI report, and wherein the CSI report includes at least one CSI component based on the at least one CB mapping type.
22. The method of clause 21, wherein the indicator identifies the recommended CB mapping type, and the one CSI trigger state is associated with the recommended CB mapping type.

23. The method of clause 21 or 22, wherein the at least one CSI component is based on a CSI reference resource assumption corresponding to the at least one CB mapping type for the aperiodic CSI report.
24. An apparatus for wireless communication for a base station, comprising: a memory storing computer-executable instructions; and at least one processor coupled to the memory and configured to execute the computer-executable instructions to perform the method of any of clauses 14-23.
25. An apparatus for wireless communication for a base station, comprising means for performing the method of any of clauses 14-23.
26. A non-transitory computer-readable medium storing computer executable code, the code when executed by a processor of a base station causes the processor to perform the method of any of clauses 14-23.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication at a user equipment (UE), comprising:
transmitting an indicator that a recommended CB mapping type is preferred by the UE over a current CB mapping type;
receiving a trigger of an aperiodic channel state information (CSI) report associated with CB mapping information; and
transmitting the aperiodic CSI report for one or more CB mapping types in response to the trigger.

2. The method of claim 1, wherein the aperiodic CSI report includes an identifier of the recommended CB mapping type and a corresponding CSI component based on the recommended CB mapping type.

3. The method of claim 2, wherein the aperiodic CSI report includes the identifier of the recommended CB mapping type, a rank indicator, a precoding matrix indicator, and a channel quality indicator.

4. The method of claim 1, further comprising receiving a configuration of CB mapping types for the UE.

5. The method of claim 1, wherein the aperiodic CSI report includes a plurality of CSI components, each CSI component based on a respective CB mapping type associated with an identifier of the aperiodic CSI report.

6. The method of claim 5, further comprising receiving a configuration of the aperiodic CSI report including a subset of CB mapping types configured for the UE that are associated with the identifier of the aperiodic CSI report.

7. The method of claim 5, wherein each CSI component is based on a CSI reference resource assumption corresponding to the respective CB mapping type.

8. The method of claim 1, further comprising receiving an activation of one CSI trigger state of a plurality of CSI trigger states for the aperiodic CSI report, wherein the CSI trigger state is associated with at least one CB mapping type for the aperiodic CSI report, and wherein the CSI report includes at least one CSI component based on the at least one CB mapping type.

9. The method of claim 8, wherein the indicator identifies the recommended CB mapping type, and the one CSI trigger state is associated with the recommended CB mapping type.

10. The method of claim 8, wherein the at least one CSI component is based on a CSI reference resource assumption corresponding to the at least one CB mapping type for the aperiodic CSI report.

11. A method of wireless communication at a base station, comprising:
receiving an indicator that a recommended CB mapping type is preferred by a user equipment (UE) over a current CB mapping type for the UE;
transmitting a trigger of an aperiodic channel state information (CSI) report associated with CB mapping information; and
receiving the aperiodic CSI report for one or more CB mapping types in response to the trigger.

12. The method of claim 11, wherein the aperiodic CSI report includes an indicator of the recommended CB mapping type and a corresponding CSI component based on the recommended CB mapping type.

13. The method of claim 12, wherein the aperiodic CSI report includes the indicator of the recommended CB mapping type, a rank indicator, a precoding matrix indicator, and a channel quality indicator.

14. The method of claim 11, further comprising transmitting a configuration of CB mapping types for the UE.

15. The method of claim 11, wherein the CSI report includes a plurality of CSI components, each CSI component based on a respective CB mapping type associated with an identifier of the aperiodic CSI report.

16. The method of claim 15, further comprising transmitting a configuration of the aperiodic CSI report including a subset of CB mapping types configured for the UE that are associated with the identifier of the aperiodic CSI report.

17. The method of claim 15, wherein each CSI component is based on a CSI reference resource assumption corresponding to the respective CB mapping type.

18. The method of claim 11, further comprising transmitting an activation of one CSI trigger state of a plurality of CSI trigger states for the aperiodic CSI report, wherein the CSI trigger state is associated with at least one CB mapping type for the aperiodic CSI report, and wherein the CSI report includes at least one CSI component based on the at least one CB mapping type.

19. The method of claim 18, wherein the indicator identifies the recommended CB mapping type, and the one CSI trigger state is associated with the recommended CB mapping type.

20. The method of claim 18, wherein the at least one CSI component is based on a CSI reference resource assumption corresponding to the at least one CB mapping type for the aperiodic CSI report.

21. An apparatus for wireless communication at a user equipment (UE), comprising:
a memory storing computer-executable instructions; and
at least one processor coupled to the memory and configured to execute the computer-executable instructions to:
transmit an indicator that a recommended CB mapping type is preferred by the UE over a current CB mapping type;
receive a trigger of an aperiodic channel state information (CSI) report associated with CB mapping information; and
transmit the aperiodic CSI report for one or more CB mapping types in response to the trigger.

22. The apparatus of claim 21, wherein the aperiodic CSI report includes an identifier of the recommended CB mapping type and a corresponding CSI component based on the recommended CB mapping type.

23. The apparatus of claim 22, wherein the aperiodic CSI report includes the identifier of the recommended CB mapping type, a rank indicator, a precoding matrix indicator, and a channel quality indicator.

24. The apparatus of claim 21, wherein the at least one processor is configured to receive a configuration of CB mapping types for the UE.

25. The apparatus of claim 21, wherein the aperiodic CSI report includes a plurality of CSI components, each CSI component based on a respective CB mapping type associated with an identifier of the aperiodic CSI report.

26. The apparatus of claim 25, wherein the at least one processor is configured to receive a configuration of the aperiodic CSI report including a subset of CB mapping types configured for the UE that are associated with the identifier of the aperiodic CSI report.

27. The apparatus of claim 25, wherein each CSI component is based on a CSI reference resource assumption corresponding to the respective CB mapping type.

28. The apparatus of claim 21, wherein the at least one processor is configured to receive an activation of one CSI trigger state of a plurality of CSI trigger states for the aperiodic CSI report, wherein the CSI trigger state is associated with at least one CB mapping type for the aperiodic CSI report, and wherein the CSI report includes at least one CSI component based on the at least one CB mapping type.

29. The apparatus of claim 28, wherein the indicator identifies the recommended CB mapping type, and the one CSI trigger state is associated with the recommended CB mapping type.

30. An apparatus for wireless communication at a base station, comprising:
a memory storing computer-executable instructions; and
at least one processor coupled to the memory and configured to execute the computer-executable instructions to:
receive an indicator that a recommended CB mapping type is preferred by a user equipment (UE) over a current CB mapping type for the UE;
transmit a trigger of an aperiodic channel state information (CSI) report associated with CB mapping information; and
receive the aperiodic CSI report for one or more CB mapping types in response to the trigger.
